(19) United States
(12) Patent Application Publication
(10) Pub. No.: US 2011/0093645 A1
(43) Pub. Date: Apr. 21, 2011

(54) METHOD AND APPARATUS TO RECORD DATA, METHOD AND APPARATUS TO REPRODUCE DATA, AND RECORDING MEDIUM

(75) Inventors: In-sik RYU, Suwon-si (KR); Se-wook Na, Suwon-si (KR); Ju-young Lee, Seoul (KR); Kyung-ho Kim, Seongnam-si (KR)

(73) Assignee: Samsung Electronics Co., Ltd., Suwon-si (KR)

(21) Appl. No.: 12/905,279

(22) Filed: Oct. 15, 2010

(30) Foreign Application Priority Data
Oct. 16, 2009 (KR) 2009-0098775

(51) Int. Cl. G06F 12/08; G06F 12/10

(52) U.S. Cl. 711/3; 711/113; 711/E12.058; 711/E12.019

(57) ABSTRACT

A data recording method including, when moving data stored in a cache to a data storage medium, selecting one cache area from an extended cache area group of the data storage medium by using managing information of a translation layer, moving the data stored in the cache to the selected cache area by using a physical address of the data storage medium on the selected cache area, and updating the managing information of the translation layer, wherein the managing information of the translation layer includes a physical block address-based address of the extended cache area group in the data storage medium.

### CROSS-REFERENCE TO RELATED APPLICATIONS

This application claims priority under 35 U.S.C. §119(a) from Korean Patent Application No. 10-2009-0098775, filed on Oct. 16, 2009, in the Korean Intellectual Property Office, the disclosure of which is incorporated herein in its entirety by reference.

### BACKGROUND

1. Field of the Invention

The present general inventive concept relates to data recording and reproducing, and more particularly, when recording or reproducing data at the request of a host, to an apparatus and method of recording data using a cache, an apparatus and method of reproducing data using a cache, and a computer-readable recording medium in which a program performing a method of recording or reproducing data using a cache is recorded.

2. Description of the Related Art

In general, an example of an apparatus for recording or reproducing data at the request of a host is a hard disk drive. A hard disk drive records data on a disk (or platter) or reproduces data recorded on the disk according to at the command of a host.

A hard disk drive has a mass storage capacity, but has a slow data recording and reproducing speed. Accordingly, in order to improve the data recording and reproducing speed of hard disk drives, a hard disk drive having a cache between a host and a disk has been proposed. The foregoing cache is also called a cache memory.

However, when moving data stored in a cache to a disk according to a cache flush command during data recording, since a head is moved to an actual position on the basis of an address included in the command of the host, the overhead for data recording is large.

Also, in reproducing data, data recorded on an actual position of a disk based on an address included in a host command, and data recorded on a position physically adjacent to the foregoing data are read together and then moved to a cache. At this time, in the case where data to be subsequently reproduced and data currently being read are recorded on positions that are not physically adjacent to each other, since data recorded on the actual position of the disk should be read using the address included in the host command, the cache hit rate is lowered.

### SUMMARY

The present general inventive concept provides method and apparatus for recording data using an extended cache area of a data storage medium based on a translation layer managing information.

Additional features and utilities of the present general inventive concept will be set forth in part in the description which follows and, in part, will be obvious from the description, or may be learned by practice of the general inventive concept.

Exemplary embodiments of the present general inventive concept provide a method and apparatus to reproduce data using an extended cache area of a data storage medium based on a translation layer managing information.

Exemplary embodiments of the present general inventive concept also provide a computer-readable recording medium in which a program performing a method of recording or reproducing data using an extended cache area of a data storage medium based on a translation layer managing information is recorded.

Exemplary embodiments of the present general inventive concept provide a data recording method, the method including when moving data stored in a cache to a data storage medium, selecting one cache area from an extended cache area group of the data storage medium by using managing information of a translation layer, moving the data stored in the cache to the selected cache area by using a physical address of the data storage medium on the selected cache area, and updating the managing information of the translation layer, wherein the managing information of the translation layer includes a physical block address-based address of the extended cache area group in the data storage medium.

The extended cache area group can include a plurality of cache areas, each of the plurality of cache areas includes a plurality of reserved blocks, and a size of the cache area is equal to a size of the cache. The one cache area can be selected according to at least the number of the reserved blocks included in each of the plurality of cache areas, and the reserved blocks are valid blocks to record data to.

The method may also include moving data from the extended cache area group to an actual position of the data storage medium by using the managing information of the translation layer, wherein the actual position of the data storage medium is according to at least the physical block address of the data storage medium corresponding to a logical block address received from a host, where the moving of data from the extended cache area group to an actual position of the data storage medium includes selecting one cache area from the extended cache area group according to the number of accesses, moving data recorded on the cache area selected according to the number of accesses to the actual position of the data storage medium; and updating the managing information of the translation layer, where the number of accesses is included in the managing information of the translation layer.

Exemplary embodiments of the present general inventive concept also provide a data recording apparatus, the apparatus including a data storage medium assembly including a data storage medium having an extended cache area group; a translation layer unit having managing information of a translation layer; a cache storing data received from a host, and a controller moving the data stored in the cache to one cache area selected from the extended cache area group by using an address according to at least the managing information of the translation layer, where the managing information of the translation layer includes a physical block address-based address of the data storage medium for the extended cache area group, and when the data stored in the cache is moved to one cache area, the managing information of the translation layer is updated.

The translation layer unit selects one cache area from the extended cache area group according to at least the number of reserved blocks included in each cache area, and provides a physical block address of the selected cache area to the controller, and the controller moves the data by using the physical block address.

The controller further includes a function to move data recorded in one cache area included in the extended cache area group to an actual position of the data storage medium, the actual position of the data storage medium is according to at least the physical block address of the data storage medium corresponding to a logical block address received from a host, and the physical block address is provided from the translation layer unit.

Exemplary embodiments of the present general inventive concept provide that when moving data recorded in one cache area to the actual position of the data storage medium, the translation layer unit selects one cache area from the extended cache area group according to the number of accesses, provides information on the actual position of the data storage medium to the controller such that the data recorded on the cache area selected according to the number of accesses is moved to the actual position of the data storage medium, and updates the managing information of the translation layer, wherein the number of accesses is included in the managing information of the translation layer.

The extended cache area group is set in an outer area of the data storage medium.

Exemplary embodiments of the present general inventive concept also provide a computer readable recording medium in which a program performing a method of recording or reproducing data by using an extended cache area of a data storage medium according to managing information of a translation layer is recorded.

Exemplary embodiments of the present general inventive concept also provide a data reproducing method, the method including when it is determined that data to be reproduced exists in one cache area included in an extended cache area group of a data storage medium, replacing data stored in a cache with data recorded in the one cache area by using managing information of a translation layer, updating the managing information of the translation layer, and transmitting the data stored in the cache to a host, where a size of the one cache area is equal to a size of the cache, and the managing information of the translation layer includes a physical block address-based address of the extended cache area group set in the data storage medium.

Exemplary embodiments of the present general inventive concept also provide a data reproducing apparatus that includes a data storage medium assembly including a data storage medium having an extended cache area group, a translation layer unit having managing information of a translation layer; a cache to store data received from a host, and a controller to replace the data stored in the cache with data recorded in one cache area of the extended cache area group by using the managing information of the translation layer, wherein the managing information of the translation layer includes a physical block address-based address of the data storage medium for the extended cache area group, and when the replacing is completed, the managing information of the translation layer is updated.

Exemplary embodiments of the present general inventive concept also provide a data recording and reproducing apparatus that includes a data storage medium assembly including a data storage medium having an extended cache area group, a translation layer unit having managing information of a translation layer, a cache to store data received from a host, and a controller, when recording data, to move the data stored in the cache to one cache area selected from the extended cache area group by using the managing information of the translation layer, and when reproducing data, to replace the data stored in the cache with data recorded in one cache area of the extended cache area group by using the managing information of the translation layer, wherein the managing information of the translation layer includes a physical block address-based address of the data storage medium for the extended cache area group, and when recording or reproducing data, the managing information of the translation layer is updated.

Exemplary embodiments of the present general inventive concept also provide a method of moving data stored in a cache memory to a data storage medium, the method including selecting a cache area of the data storage medium by using managing information stored in a translation apparatus that includes an address of the cache area, moving the data stored in the cache memory to the selected cache area of the data storage medium by using an address of the selected cache area of the data storage medium, and updating the managing information stored in the translation apparatus.

The method may also include that when it is determined that a cache area group that includes the selected cache area is in a full state, selecting a cache area from the cache area group, moving data recorded on the selected cache area to a predetermined location of the data storage medium, and updating the managing information stored in the translation apparatus.

Exemplary embodiments of the present general inventive concept also provide a data recording apparatus including a cache memory and a translation apparatus, including a data storage assembly including a data storage medium, a cache area group of the data storage medium, and a controller to select a cache area of the cache area group by using managing information stored in the translation apparatus that includes an address of the cache area, to move the data stored in the cache memory to the selected cache area of the data storage medium by using an address of the selected cache area of the data storage medium, and to update the managing information stored in the translation apparatus.

The data recording apparatus can include where the controller determines that the selected cache area is in a full state and selects a second cache area from the cache area group, moves data recorded on the selected second cache area to a predetermined location of the data storage medium, and updates the managing information stored in the translation apparatus.

Exemplary embodiments of the present general inventive concept also provide a method of reading data, the method including receiving a data read command from a host apparatus, when the data requested in the received data read command is stored in a cache area of a data storage medium, replacing the data stored in a cache memory with the data stored in the cache area of the data storage medium, updating managing information stored in a translation apparatus, and transmitting the data stored in the cache to the host apparatus.

The method may also include that when the data requested in the received data read command is not stored a cache area of a data storage medium, accessing the data storage medium to retrieve the requested data, and transmitting the data stored in the data storage medium to the host apparatus.

The method may also include accessing the data storage medium to retrieve the requested data using the managing information stored in a translation apparatus.

Exemplary embodiments of the present general inventive concept also provide an apparatus to read data, including a cache memory, a data storage apparatus including a data storage medium, a controller to receive a data read command from a host device, when the data requested in the received data read command is stored a cache area of the data storage medium, to replace data stored in the cache memory with the data stored in the cache area of the data storage medium, and to update managing information stored in a translation apparatus, and an interface to transmit the data stored in the cache to the host apparatus.

The apparatus may include that when the data requested in the received data read command is not stored a cache area of the data storage medium, the controller accesses the data storage medium to retrieve the requested data, and the interface transmits the data stored in the data storage medium to the host apparatus.

The apparatus may include where the controller accesses the data storage medium to retrieve the requested data using the managing information stored in a translation apparatus.

### BRIEF DESCRIPTION OF THE DRAWINGS

Exemplary embodiments of the present general inventive concept will be more clearly understood from the following detailed description taken in conjunction with the accompanying drawings in which:

FIG. 1 is a functional block diagram illustrating a data recording and reproducing apparatus 100 according to exemplary embodiments of the present general inventive concept;

FIG. 2 is a detailed configurative view illustrating a data storage medium assembly of FIG. 1;

FIG. 3 illustrates an example of an extended cache area group included in a data storage medium of FIG. 2;

FIGS. 4A through 4F illustrate examples of updating managing information of a translation layer according to exemplary embodiments of the present general inventive concept;

FIG. 5 is an operational flowchart illustrating a data recording method according to exemplary embodiments of the present general inventive concept;

FIG. 6 is an operational flowchart illustrating a data recording method according to exemplary embodiments of the present general inventive concept; and

FIG. 7 is an operational flowchart illustrating a data reproducing method according to exemplary embodiments of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

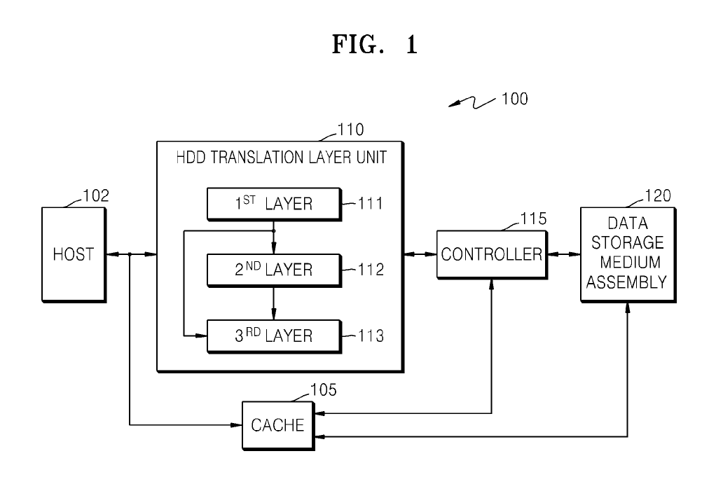

FIG. 1 is a functional block diagram illustrating a data recording and reproducing apparatus 100 according to exemplary embodiments of the inventive concept, and illustrates an example of the data recording and reproducing apparatus 100 applied to a hard disk drive. Referring to FIG. 1, the data recording and reproducing apparatus 100 can include a cache 105, a hard disk drive (HDD) translation layer unit 110, a controller 115, and a data storage medium assembly (DA or head DA (HDA)) 120. The data recording and reproducing apparatus 100 of FIG. 1 may be a data recording apparatus and/or a data reproducing apparatus.

The cache 105 can temporarily store data received from a host 102. The host 102 may be communicatively coupled to the cache 105 and/or the HDD translation layer unit 110 via a wired and/or wired communication network. Data may be transmitted between the host 102 and the cache 105 and/or the HDD translation layer unit 110 via the wired and/or wireless communication network. The cache 105 may be also called a cache memory. While a memory such as a flash memory, random access memory (RAM), a NAND memory, or a synchronous memory may be used as the cache 105, a memory (e.g., a flash memory) having a fast access speed (e.g., a memory device having an increased access speed compared to, for example, a hard disk drive) is preferably used. However, the cache 105 is not limited to the foregoing memories.

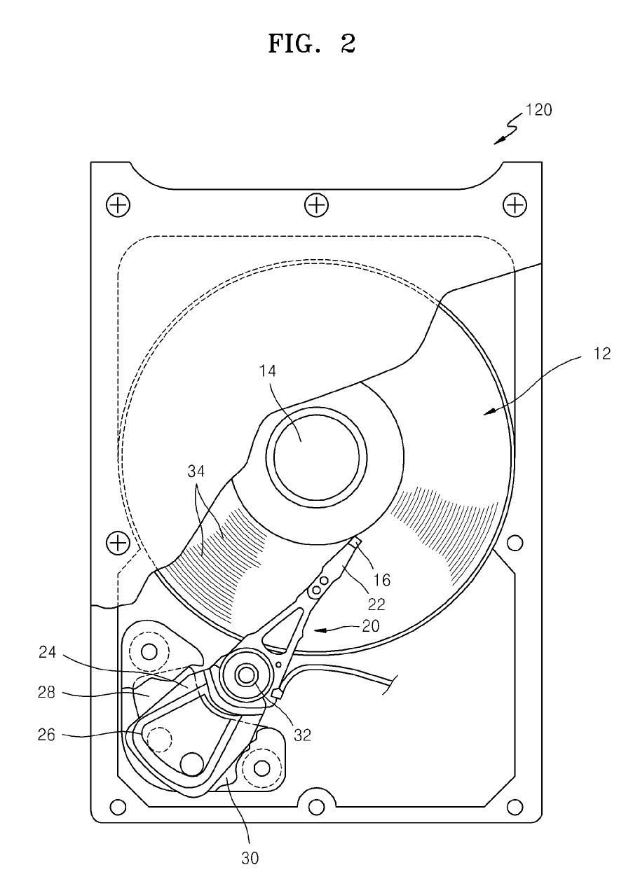

When the data recording and reproducing apparatus 100 is a hard disk drive (HDD), the DA 120 may be called a head disk assembly or a head data storage medium assembly (HDA). The DA 120 may be configured as illustrated in FIG. 2, but is not limited to the configuration illustrated in FIG. 2.

The DA 120 may include at least one data storage medium 12 rotated by a spindle motor 14. The data storage medium 12 may be a magnetic disk. The DA 120 may include a head 16 positioned adjacent to a surface of the data storage medium 12. The head 16 may be a converter (e.g., to convert a magnetic field to an electrical signal, and/or convert an electrical signal representing data into a magnetic field).

The head 16 may read data from the rotating data storage medium 12 or write data on the rotating data storage medium 12 by sensing a magnetic field of the data storage medium 12 and magnetizing the data storage medium 12. Typically, the head 16 can be coupled to the surface of the data storage medium 12. While FIG. 2 illustrates the DA 120 having a single head 16, it should be understood that the head 16 can be a recording head to magnetize the data storage medium 12 and a reproducing head to sense the magnetic field of the data storage medium 12. The reproducing head may include a magneto-resistive (MR) element.

The head 16 may be integrated into a slider 20. The slider 20 can include an air bearing between the head 16 and a surface of the data storage medium 12. The slider 20 can be coupled to a head gimbal assembly 22. The head gimbal assembly 22 can be attached to an actuator arm 24 having a voice coil 26. The voice coil 26 can be positioned adjacent to a magnetic assembly 28 to form a voice coil motor (VCM) 30. A current supplied to the voice coil 26 can generate a torque that rotates the actuator arm 24 with respect to the bearing assembly 32. The rotation of the actuator arm 24 can move the head 16 across the surface of the data storage medium 12.

Data can be typically stored in a ring-shaped track of the data storage medium 12. Each track 34 can generally include a plurality of sectors. Each sector can include a data field and an identification field. The identification field can include gray codes to identify the sectors and the tracks. The head 16 can move when crossing the surface of the data storage medium to reproduce information of other tracks and/or record information.

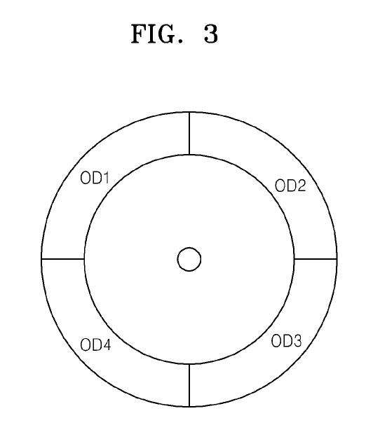

The data storage medium 12 can have an extended cache area group including four cache areas (Outer Diameter (OD)1-OD4) along an outer area thereof, as illustrated in FIG. 3. However, the extended cache area group is not limited to the configuration of FIG. 3 that includes four cache areas. For example, when the cache 105 is X megabytes, the extended cache area group may have an N number of X-megabyte cache areas according to the capacity of the data storage medium 12 and the capacity of the cache 105, where N is a natural number of 2 or more. Thus, the size of the cache area included in the extended cache area group can be set to a size equal to the size of the cache 105. Accordingly, data may be recorded on or reproduced from the data storage medium 12 in the cache 105 unit. The cache 105 unit may be defined as several continuous command units.

The extended cache area group of the data storage medium 12 may be set in advance. Each of the plurality of cache areas included in the extended cache area group can include a plurality of reserved blocks. The reserved block can be a valid block, which is ready to record data. The greater the number of reserved blocks in a cache area, the more preferentially the cache area from among cache areas within the extended cache area group may be selected during data recording.

The HDD translation layer unit 110 can interface between the host 102 (illustrated in FIG. 1) and the controller 115. Therefore, the HDD translation layer unit 110 may be referred to as an interface unit. The host 102 may be, for example, an apparatus operating according to a Windows-based operation system program. For example, the host 102 may be a computer system, a smartphone, a cellular telephone, a personal digital assistant, a tablet computer, a processor, an application specific integrated circuit (ASIC), a programmable logic device, a field programmable gate array, or any other suitable device to carry out the exemplary embodiments of the present general inventive concept as disclosed herein.

The HDD translation layer unit 110 may be a translation layer unit as the HDD translation layer unit 110 can perform a translation operation to translate a logical block address (LBA) received from the host 102 into a physical block address (PBA) of the data storage medium 12. For this translation operation, the HDD translation layer unit 110 can manage information of the translation layer.

The managing information of the translation layer may include an address according to at least the physical block address (PBA) of the data storage medium 12 for the extended cache area group of the data storage medium 12, and the number of accesses to the cache area included in the extended cache area group. Accordingly, the managing information of the translation layer may be also referred to as managing information of the extended cache area group of the data storage medium 12 or meta data of the extended cache area group, and may be in the form of a table. The physical block address-based address may be a virtual address.

As the HDD translation layer unit 110 can select one cache area from the extended cache area group according to the number of the reserved blocks included in each cache area, the managing information of the translation layer may include cache area information according to at least the number of the reserved blocks included in each cache area, and/or cache area metadata.

To move data recorded on the cache area of the data storage medium 12 to an actual position on the data storage medium 12, the managing information of the translation layer may include mapping information that may map the substantial physical block address (PBA) of the data storage medium 12 corresponding to the logical block address (LBA) received from the host 102. The mapping information may include information on a corresponding cache area.

When data recorded on the cache area of the data storage medium 12 is changed, the managing information of the translation layer may be updated.

To perform a translation operation using the foregoing managing information of the translation layer, the HDD translation layer unit 110 may include a first layer 111, a second layer 112, and a third layer 113.

The first layer 111 can divide commands received from the host 102 into data commands and non-data commands, and may be defined as an HDD interface layer (HIL). The data command may include a read command (or reproduce command), and a write command (or record command). The non-data command may include a set feature command, which changes the setting of the data storage medium assembly 120, a standby command, and a reset command. When received data is the data command, the first layer 111 can call the second layer 112, when received data is the non-data command, the first layer 111 can immediately call the third layer 113 such that the controller 115 can control an operation of the data storage medium assembly 120 according to the non-data command.

The second layer 112 can translate LBA included in the data command received from the first layer 111 into a virtual address (VA) by using the managing information of the translation layer. Accordingly, the second layer 112 may be a virtual mapping layer (VML). The VA may be set according to a physical address of the extended cache area group that is preset in the data storage medium 12.

That is, the second layer 112 can have the managing information of the translation layer including a physical address-based VA of the extended cache area group of the data storage medium 12 to move data stored in the cache 105 to the extended cache area group of the data storage medium 12 regardless of the LBA received from the host 102, or to replace data stored in the cache 105 with data recorded on one cache area included in the extended cache area group.

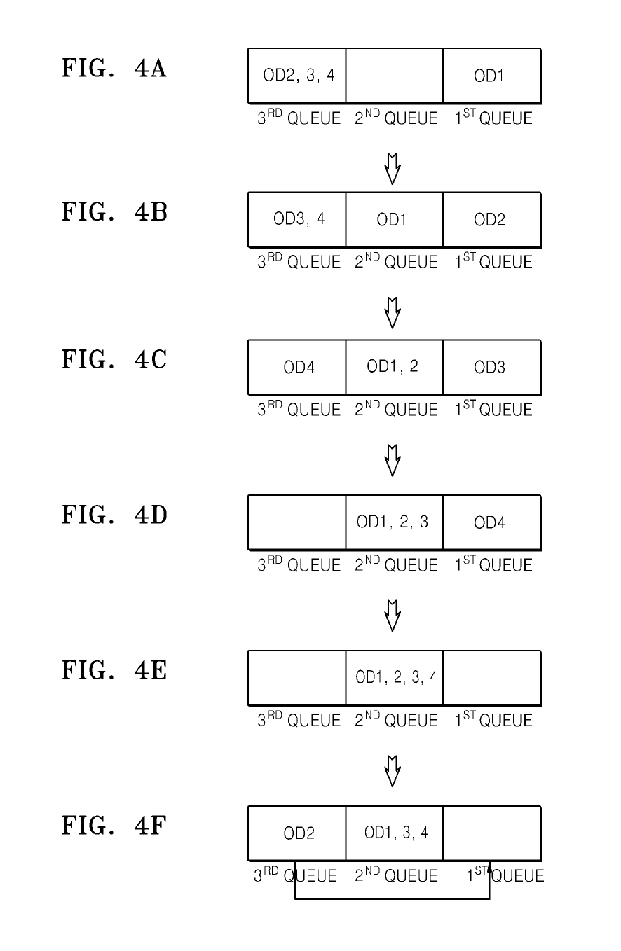

The VA included in the managing information of the translation layer may be defined with respect to each of the cache areas included in the extended cache area group. FIGS. 4A through 4F illustrate examples in which VAs can be defined with respect to the respective cache areas by using first to third queues, and the managing information of the translation layer can be updated according to the use of the extended cache area group of the data storage medium 12.

When the managing information of the translation layer is defined as illustrated in FIG. 4A, among the cache areas of the data storage medium 12, OD1 can be an area that may move data stored in the cache 105. Among OD1 to OD4, OD1 can have the largest number of reserved blocks and can be the cache area having the highest priority to record data.

When a cache flush command is received from the controller 115 and/or the host 102 to move data stored in the cache 105 to the data storage medium 12, the second layer 112 can select one cache area from the extended cache area group of the data storage medium 12 by using the managing information of the translation layer. When the cache 105 is in a full state and/or the data recording and reproducing apparatus 100 is in an idle state, the cache flush command may be generated, but the generation of the cache flush command is not limited to the foregoing circumstance.

When the managing information of the translation layer is as illustrated in FIG. 4A, the second layer 112 can select OD1 positioned at the first queue from the extended cache area group of the data storage medium 12. When the data stored in the cache 105 is moved to the selected OD1, the managing information of the translation layer is updated as illustrated in FIG. 4B.

When a cache flush command is received (e.g., when a next cache flush command is received), the second layer 112 can select OD2 positioned at the first queue from the extended cache area group of the data storage medium 12. When the data stored in the cache 105 is moved to the selected OD2, the managing information of the translation layer can be updated as illustrated in FIG. 4C.

When a cache flush command is received (e.g., when a next cache flush command is received), the second layer 112 can select OD3 positioned at the first queue from the extended cache area group of the data storage medium 12. When the data stored in the cache 105 is moved to the selected OD3, the managing information of the translation layer can be updated as illustrated in FIG. 4D.

When a cache flush command is again received (e.g., a next cache flush command is again received), the second layer 112 can select OD4 positioned at the first queue from the extended cache area group of the data storage medium 12. When the data stored in the cache 105 is moved to the selected OD4, the managing information of the translation layer can be updated as illustrated in FIG. 4E. Accordingly, the extended cache area group of the data storage medium 12 can be in a “full” state.

When the extended cache area group of the data storage medium 12 is a full state or the data recording and reproducing apparatus 100 is an idle state, the data recorded in the extended cache area group can be moved to an actual position on the data storage medium 12.

The second layer 112 can select one cache area according to the number of accesses of the plurality of cache areas (e.g., OD1 to OD4) included in the extended cache area group. That is, a cache area having a low number of accesses (e.g., a cache area having a low number of accesses compared to a predetermined number of accesses) among the plurality of caches areas included in the extended cache area group or a cache area having a lowest number of accesses among the plurality of caches areas included in the extended cache area group may be selected. When the number of accesses for a cache area is lower than a predetermined value or that of another cache area, the data stored in the cache area can have a decreased possibility and/or low possibility of being requested by the host 102.

As the cache area having the low number of accesses or having a lowest number of accesses is selected, the managing information of the translation layer can be updated as illustrated in FIG. 4F. Referring to FIG. 4F, of OD1 to OD4, OD2 in the third queue is the cache area with the lowest number of accesses. A corresponding address can be provided to the third layer 113 such that data recorded in OD2 in the third queue is moved to the actual position of the data storage medium 12. The actual position of the data storage medium 12 is according to at least a PBA of the data storage medium corresponding to an LBA received from the host 102.

When data recorded in OD2 is moved to an actual position of the data storage medium 12, information on OD2 can be moved to the first queue and may be selected when the next cache flush command is generated.

As described above, the first queue provided on the second layer 112 may be a queue to manage information on a cache area that may be selected when recording data according to the number of reserved blocks or the number of accesses. The second queue may be a queue to manage information on a cache area of the data storage medium 12 to which data stored in a cache is moved, that is, information on a used cache area. The third queue may be a queue to manage information on a cache area that may move data recorded to an actual position on the data storage medium 12 according to the number of accesses.

Managing information of the translation layer on the second layer 112 can include position information on the cache 105 and/or extended cache region and mapping information between LBAs of data recorded in the cache 105 or extended cache area. Accordingly, when data reproduction (data read) is requested by a host 102, the mapping information can be referred to according to at least an LBA included in the command given (e.g., request from the host 102), and it may be determined whether the data required for reproduction by the host 102 is data stored in the cache 105 or data stored in an extended cache area group of the data storage medium 12. The results determined in the second layer 112 can be transmitted to the controller 115.

If it is determined that the data required by the host 102 is data stored in the cache 105, the controller 115 can transmit the data stored in the cache 105 to the host 102. If the reference to the mapping information illustrates that the data for reproduction by the host 102 is data stored in one cache area from among the extended cache area group of the data storage medium 12, the second layer 112 transmits a VA for the corresponding cache area to the third layer 113. The third layer 113 can translate the VA into a physical address of the corresponding data storage medium 12 to replace the data stored in the cache 105 with the data recorded on a corresponding cache area.

The third layer 113 can translate the VA on the cache area transmitted from the second layer 112 into a cylinder head sector (CHS), which is a physical address of the data storage medium 12, and can provide the translated CHS to the controller 115. The controller 115 can access the data storage medium 12 of the data storage medium assembly 120 by using the received CHS.

The foregoing data storage medium assembly 120 may include storage media (e.g., any suitable storage media to carry out the exemplary embodiments of the present general inventive concept as disclosed herein) that may have a specific address value on an area thereof in addition to a hard disk using CHS. Accordingly, the foregoing VA may be applied to a storage medium other than a hard disk.

The controller 115 can monitor an operation state of the data recording and reproducing apparatus 100 and an operation state of the cache 105, can generate a cache flush when the data recording and reproducing apparatus 100 is in an idle state or the cache 105 is in a full state, and can perform a control such that the data stored in the cache 105 is moved to a cache area selected from among the extended cache area group of the data storage medium by using the PBA of the data storage medium 12 provided from the HDD translation layer unit 110. The controller can move the data recorded in the extended cache area group of the data storage medium 12 to an actual position of the data storage medium 12 by using the PBA of the data storage medium 12 provided from the HDD translation layer unit 110. In reproducing data, the controller 115 can control the cache 105 and the data storage medium assembly 120 such that the data stored in the cache 105 can be replaced by the data stored in a cache area selected from the extended cache area group.

The controller illustrated in FIG. 1 may be configured to include the HDD translation layer unit 110.

In exemplary embodiments of the present general inventive concept, when a cache flush is generated in a data recording and/or reproducing apparatus having a cache by using an extended cache area set in a data storage medium regardless of an actual position of the data storage medium, an overhead on data recording can be reduced, and a task can be performed at a sequential write speed. By setting the size of the extended cache area set in the data storage medium in an equal size to the cache, since data recording or reproducing can be performed in a cache unit, a command table can be changed due to reception of other command in updating managing information of a translation layer can be minimized and/or prevented, and a cache hit rate can be enhanced in data reproducing.

When a cache flush is generated, since the translation layer manages meta data of the extended cache area set in the data storage medium, it is possible to decrease the amount of the meta data managed by the translation layer. Since the extended cache area of the data storage medium can have valid blocks as reserved blocks by using the translation layer, generated faults in data recording and/or unexpected data corruption in performing a cache flush where the system malfunctions or falls into a trap can be minimized and/or prevented.

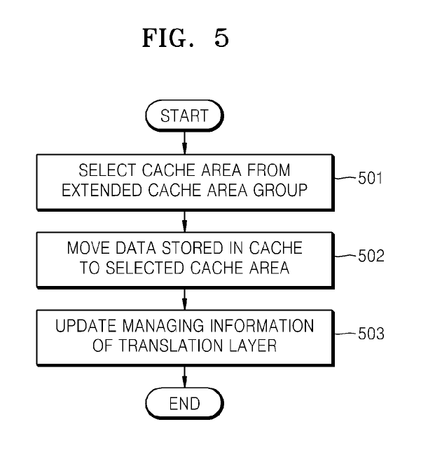

FIG. 5 illustrates an operational flowchart of a data recording method according to exemplary embodiments of the present general inventive concept. The operational flowchart will now be described with reference to FIGS. 1 and 4A through 4F.

When a cache flush is generated to move data stored in the cache 105 to the data storage medium 12, the HDD translation layer unit 110 can select one cache area from the extended cache area group of the data storage medium 12 by using managing information of a translation layer in operation 501. That is, as described with reference to FIGS. 1 and 4A through 4F, of the queues included in the managing information of the translation layer, the cache area in the first queue may be selected. The cache area in the first queue can be a cache area having the greatest number of reserved blocks among the cache areas in the data storage medium 12. Selection of a cache area can be performed according to at least the number of reserved blocks included in a cache area.

The managing information of the translation layer can manage information on the extended cache area group set in the data storage medium 12, and can manage information and/or meta data of the extended cache area group. The managing information of the translation layer may include a virtual address (VA) according to at least a physical address of the extended cache area group set (e.g., set in advance and/or set at a predetermined time) in the data storage medium 12.

The extended cache area group of the data storage medium 12 can include a plurality of cache areas. Each of the plurality of cache areas can include a plurality of reserved blocks. A size of each cache area included in the extended cache area group set in the data storage medium 12 can be equal to a size of the cache 105.

When one cache area is selected, the HDD translation layer unit 110 can provide the physical address of the data storage medium 12 for the selected cache area to the controller 115. The controller 115 can move the data stored in the cache 105 to the selected cache area in the data storage medium 12 in operation 502.

When the data stored in the cache 105 is moved to the selected cache area in the data storage medium 12, the HDD translation layer unit 110 can update the managing information of the translation layer as described with reference to FIGS. 4A through 4F in operation 503.

The foregoing operations 501 to 503 may be performed, for example, whenever a cache flush is generated. The cache flush may be generated when the data recording and reproducing apparatus 100 is in an idle state or the cache 105 is in a full state, but may be provided from the host 102.

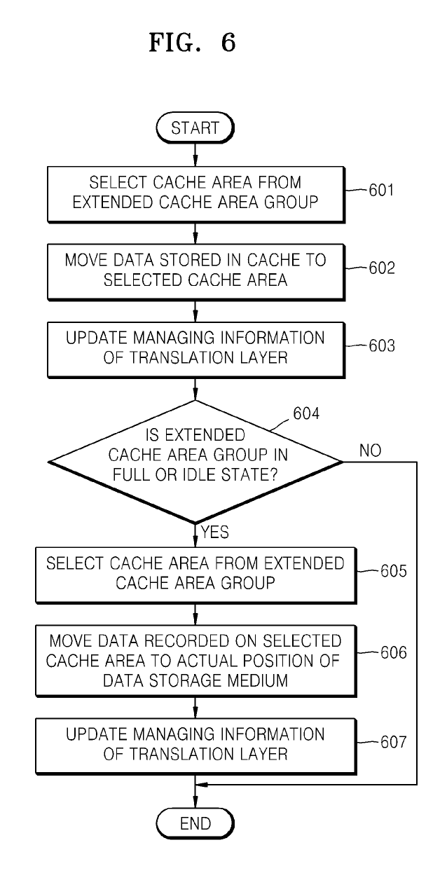

FIG. 6 illustrates an example of an addition function to the data recording method illustrated in FIG. 5, to move data from the extended cache area group set in the data storage medium 12 to an actual position on the data storage medium 12, when the extended cache area set in the data storage medium 12 is in a full state or when the data storage and reproducing apparatus 100 is in an idle state. Thus, operations 601 to 603 are the same as operations 501 to 503 in FIG. 5, operation 603 is the same as operations 503 and 603 in FIGS. 5 and 6, respectively, and a detailed description thereof will not be provided below in order to avoid repetition.

If the controller 115 determines in operation 604 that the extended cache area group is in a full state or that the data recording and reproducing apparatus 100 is in an idle state, a cache area selection can be requested to the HDD translation layer unit 110.

The HDD translation layer unit 110 can select one cache area from the extended cache area group set in the data storage medium 12 in operation 605. The cache area selection may be performed according to the number of accesses for each cache area. That is, a cache area having a small number of accesses or a lowest number of accesses is selected. A small number of accesses can indicate that the data has been read little by the host 102 (e.g., less than a predetermined amount and/or less than a predetermined reference value or less than the number of accesses for another cache area). To select a cache area having a small number of accesses or a cache area having a lowest number of accesses, the HDD translation layer unit 110 may use the managing information of the translation layer described above. The managing information of the translation layer can include information on the number of accesses for each cache area. Accordingly, by comparing the number of accesses for each cache area using the managing information, the cache area having a lowest number of accesses can be selected.

When a cache area is selected, the HDD translation layer unit 110 can provide the controller 115 with the physical address of the selected cache area. When the data stored in the selected cache area is received, the HDD translation layer unit 110 can provide the controller 115 with the actual position of the data storage medium 12, that is, the PBA, according to at least an LBA provided by the host 102. Therefore, the actual position of the data storage medium 12 may be defined according to at least the physical block address of the data storage medium 12 that corresponds to the logical block address received from the host 102.

The controller 115 can use the physical address of the selected cache area set in the data storage medium 12 provided by the HDD translation layer unit 110 and the physical address corresponding to the actual position of the data storage medium 12, to move the data stored in the selected cache area to the actual position of the data storage medium 12 in operation 606.

When the moving of data from the cache area to the actual position of the data storage medium 12 has been completed, the HDD translation layer unit 110 can update the managing information of the translation layer. Thus, the managing information of the translation layer can redefine the cache area of the data storage medium 12 that moved data to the actual position of the data storage medium 12 as the top priority cache area when recording data. That is, the selected cache region is stored in the first queue.

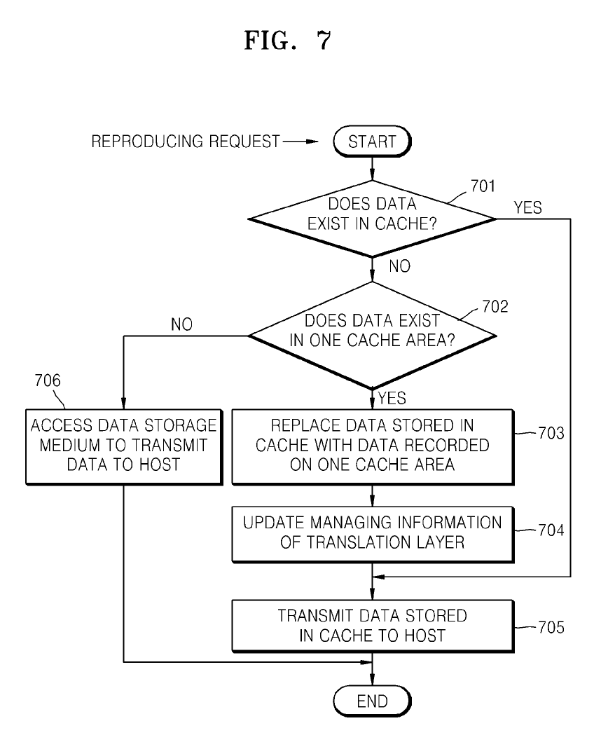

FIG. 7 is an operational flowchart illustrating a data reproducing method according to exemplary embodiments of the present general inventive concept. The operation flowchart of FIG. 7 will be now described with reference to FIG. 1.

When reproduction is required by the host 102, that is, when a data read command is received from the host 102, the HDD translation layer unit 110 can check in operation 701 whether data required for reproduction by the host 102 exists in the cache 105. The check may be performed by comparing an LBA included in the reproduction command received from the host 102 with an LBA of data stored in the cache 105 managed by the HDD translation layer unit 110.

If the checking results indicate that the data does not exist in the cache 105, the HDD translation layer 110 can check in operation 702 whether the data exists in a cache area among a plurality of cache areas in an extended cache area group set in the data storage medium 12. This check may also be performed by using an LBA of data stored in each cache area managed by the HDD translation layer unit 110.

If the checking results indicate that the data exists in one cache area, the HDD translation layer 110 can provide the controller 115 with a physical address of the data storage medium 12 for the corresponding cache area. Accordingly, the controller 115 can control the data storage medium 12 and the cache 105 in operation 703 to replace the data stored in the cache 105 with the data stored in the corresponding cache area.

When the data stored in the cache 105 is replaced by the data stored in the corresponding cache area, the HDD translation layer unit 110 can update the translation layer managing information in operation 704. That is, the data relating to the corresponding cache area from among the data included in the translation layer managing information can be updated.

Next, the controller 115 can transmit the data stored in the cache 105 to the host 102 in operation 705.

If the checking in operation 701 indicates that the data for reproduction requested by the host 102 is data stored in the cache 105, operation 705 can be performed, where the controller 115 transmits the data stored in the cache 105 to the host 102.

If the checking results in operation 702 indicates that the data does not exist in any cache region, the controller 115 can use a physical block address of the data storage medium 12 provided by the HDD translation layer unit 110 to access the data storage medium 12 and read the corresponding data, and transmits the read data to the host 102 in operation 706.

Exemplary embodiments of the present general inventive concept may be embodied as methods, apparatuses, and systems. When executed with software, exemplary embodiments of the present general inventive concept include code segments that perform operations of the exemplary embodiments disclosed herein. Programs or code segments may be stored in processor-readable media. Processor-readable media include any medium that can store or transmit data. Examples of processor-readable media include electronic circuits, semiconductor memory devices, ROM, flash memory, erasable ROM (EROM), floppy disks, optical disks, hard disks, fiber optic media, and radio frequency (RF) networks.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can be transmitted through carrier waves or signals (e.g., wired or wireless data transmission through the Internet). Also, functional programs, codes, and code segments to accomplish the present general inventive concept can be easily construed by programmers skilled in the art to which the present general inventive concept pertains.

While the present general inventive concept has been particularly illustrated and described with reference to exemplary embodiments thereof, it will be understood that various changes in form and details may be made therein without departing from the spirit and scope of the following claims.

What is claimed is:

1. A data recording method, the method comprising:
when moving data stored in a cache to a data storage medium, selecting one cache area from an extended cache area group of the data storage medium by using managing information of a translation layer;
moving the data stored in the cache to the selected cache area by using a physical address of the data storage medium on the selected cache area; and
updating the managing information of the translation layer,
wherein the managing information of the translation layer includes a physical block address-based address of the extended cache area group in the data storage medium.

2. The data recording method of claim 1, wherein the extended cache area group includes a plurality of cache areas, each of the plurality of cache areas includes a plurality of reserved blocks, and a size of the cache area is equal to a size of the cache.

3. The data recording method of claim 2, wherein the one cache area is selected according to at least the number of the reserved blocks included in each of the plurality of cache areas, and the reserved blocks are valid blocks to record data to.

4. The data recording method of claim 3, further comprising:
moving data from the extended cache area group to an actual position of the data storage medium by using the managing information of the translation layer,
wherein the actual position of the data storage medium is according to at least the physical block address of the data storage medium corresponding to a logical block address received from a host.

5. The data recording method of claim 4, wherein the moving of data from the extended cache area group to an actual position of the data storage medium comprises:
selecting one cache area from the extended cache area group according to the number of accesses;
moving data recorded on the cache area selected according to the number of accesses to the actual position of the data storage medium; and
updating the managing information of the translation layer,
wherein the number of accesses is included in the managing information of the translation layer.

6. The data recording method of claim 5, wherein the extended cache area group is set in an outer area of the data storage medium.

7. The data recording method of claim 1, wherein the extended cache area group is set in an outer area the data storage medium.

8. A method of moving data stored in a cache memory to a data storage medium, the method comprising:
selecting a cache area of the data storage medium by using managing information stored in a translation apparatus that includes an address of the cache area;
moving the data stored in the cache memory to the selected cache area of the data storage medium by using an address of the selected cache area of the data storage medium; and
updating the managing information stored in the translation apparatus.

9. The method of claim 8, further comprising:
when it is determined that a cache area group that includes the selected cache area is in a full state, selecting a cache area from the cache area group;
moving data recorded on the selected cache area to a predetermined location of the data storage medium; and
updating the managing information stored in the translation apparatus.

10. A data recording apparatus including a cache memory and a translation apparatus, comprising:
a data storage assembly including a data storage medium;
a cache area group of the data storage medium; and
a controller to select a cache area of the cache area group by using managing information stored in the translation apparatus that includes an address of the cache area, to move the data stored in the cache memory to the selected cache area of the data storage medium by using an address of the selected cache area of the data storage medium, and to update the managing information stored in the translation apparatus.

11. The data recording apparatus of claim 10, wherein the controller determines that the selected cache area is in a full state and selects a second cache area from the cache area group, moves data recorded on the selected second cache area to a predetermined location of the data storage medium, and updates the managing information stored in the translation apparatus.

12. A method of reading data, the method comprising:
receiving a data read command from a host apparatus;
when the data requested in the received data read command is stored a cache area of a data storage medium, replacing the data stored in a cache memory with the data stored in the cache area of the data storage medium;
updating managing information stored in a translation apparatus; and
transmitting the data stored in the cache to the host apparatus.

13. The method of claim 12, further comprising:
when the data requested in the received data read command is not stored a cache area of a data storage medium, accessing the data storage medium to retrieve the requested data; and
transmitting the data stored in the data storage medium to the host apparatus.

14. The method of claim 13, wherein the accessing the data storage medium to retrieve the requested data comprises:
accessing the data storage medium to retrieve the requested data using the managing information stored in a translation apparatus.

15. An apparatus to read data, comprising:
a cache memory;
a data storage apparatus including a data storage medium;
a controller to receive a data read command from a host device, when the data requested in the received data read command is stored a cache area of the data storage medium, to replace data stored in the cache memory with the data stored in the cache area of the data storage medium, and to update managing information stored in a translation apparatus; and
an interface to transmit the data stored in the cache to the host apparatus.

16. The apparatus of claim 15, wherein when the data requested in the received data read command is not stored a cache area of the data storage medium, the controller accesses the data storage medium to retrieve the requested data, and the interface transmits the data stored in the data storage medium to the host apparatus.

17. The apparatus of claim 16, wherein the controller accesses the data storage medium to retrieve the requested data using the managing information stored in a translation apparatus.
